(19) United States
(12) Patent Application Publication
(10) Pub. No.: US 2026/0215413 A1
(43) Pub. Date: Jul. 30, 2026

(54) FUNGICIDAL COMPOSITION IN MICROEMULSION FORM

(71) Applicant: SURCOS IMPACT SARL, Mamer (LU)

(72) Inventor: Félix Silvestre GALAN ROMANO, Buenos Aires (AR)

(21) Appl. No.: 19/141,780

(22) PCT Filed: Dec. 20, 2023
(86) PCT No.: PCT/IB2023/063015

§ 371 Date: Jun. 20, 2025

Related U.S. Application Data
(60) Provisional application No. 63/434,370, filed on Dec. 21, 2022.

(51) Int. Cl. A01N 25/04; A01N 37/50; A01N 43/40; A01N 43/54; A01N 43/653; A01P 3/00

(52) U.S. Cl. CPC A01N 25/04; A01N 37/50; A01N 43/40; A01N 43/54; A01N 43/653; A01P 3/00

(57) ABSTRACT

Fungicidal microemulsion composition combines a triazolinthione or triazole fungicide at 2.5-9% w/v with a methoxyacrylate strobilurin at 3.5-10% w/v, along with surfactant emulsifiers and co-solvents to generate transparent droplets of about 0.01-0.05 μm. Low-dose delivery controls ascomycete, basidiomycete, phycomycete and deuteromycete pathogens on cereals, soybeans, fruits and vegetables while reducing total active ingredient per hectare. Representative actives include prothioconazole, tebuconazole and epoxiconazole with azoxystrobin, picoxystrobin or trifloxystrobin. The formulation resists phase separation from 0° C. to 54° C., remains homogeneous in spray tanks without agitation, lessens foliage phytotoxicity, and minimizes environmental residues, providing uniform crop coverage and consistent disease suppression.

### CROSS-REFERENCE TO RELATED APPLICATIONS

This application is the U.S. national phase of International Application No. PCT/IB2023/063015 filed Dec. 20, 2023, which designated the U.S. and claims priority to provisional application No. 63/434,370 filed Dec. 21, 2022, the entire contents of each of which are hereby incorporated by reference.

### FIELD

The present disclosure is included in the field of fungicidal compositions referring to combinations of a triazolinthione and/or triazoles, and a methoxyacrylate. Preferably, among the triazolinthiones, for example prothioconazole, tebuconazole, epoxyconazole, propioconazole, among others, and on the other hand of methoxyacrylates, compounds such as the strobilurins selected from the group comprised by azoxystrobin, picoxystrobin and trifloxystrobin.

The present compositions are especially in the form of microemulsion at low concentrations.

The object of the present disclosure is to provide a fungicidal composition in microemulsion form comprising combinations of a triazolinthione and/or triazoles, and a methoxyacrylate, wherein, preferably, among the triazolinthiones we can mention as examples prothioconazole, tebuconazole, epoxyconazole, propiconazole, among others, and on the other hand of methoxyacrylates, compounds such as the strobilurins selected from the group comprising azoxystrobin, picoxystrobin and trifloxystrobin at low concentration, in microemulsion form that unexpectedly requires a lower application dose of the active ingredient per unit area of crop to which it is applied, achieving equal or enhanced benefits than the concentrated commercial formulations of the same.

### BACKGROUND

Considering triazolinthione and/or triazoles fungicides we have the following preferred in the present development:

Prothioconazole is a synthetic chemical produced primarily for its fungicidal properties. It is a member of the class of triazole compounds and possesses a toxophore unique to this class of fungicides. Its effective fungicidal properties can be attributed to its ability to inhibit CYP51A1.

Prothioconazole controls both seedborne and soilborne diseases. It allows a good crop establishment and controls those diseases that cause a decrease in plant stand from the seed. It is absorbed inside the cells of the target organisms, affecting sterol biosynthesis, producing a disorder in the cell membrane structure, ultimately affecting hyphal growth and germ tube elongation. It is the most potent curative fungicide.

It is usually marketed in the agrochemical market as a 30% w/v concentrated suspension (Bayer® Fleuver™)

The chemical formula of prothioconazole is:

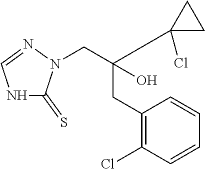 [SMILES: OC(Cc1ccccc1Cl)(Cn1nc[nH]c1=S)CC1(Cl)CC1]

Tebuconazole is a triazole fungicide used in agriculture to treat plant pathogenic fungi, it is a systemic fungicide, with preventive, curative and eradicating action. It inhibits the ergosterol biosynthesis of the fungus. It has a wide spectrum of action, standing out in the control of diseases in wheat and other crops, such as Fusarium, Septoria, rusts and powdery mildew, increasing the yield and quality of the harvest.

Tebuconazole is commercialized for example by Sumitomo® in the agrochemical market at 43% w/v SC.

Tebuconazole has the chemical formula:

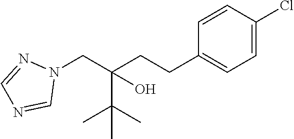 [SMILES: CC(C)(C)C(O)(CCc1ccc(Cl)cc1)Cn1cncn1]

Epoxiconazole is a fungicidal active ingredient of the azole class developed for crop protection. The substance inhibits the metabolism of fungal cells that can infest useful plants, thus preventing the growth of mycelium (fungal cells). Epoxiconazole also limits the production of conidiophores (mitospores). Epoxiconazole was introduced to the market by BASF SE in 1993 and is found in many products and product mixtures against pathogens in various crops. Examples of these crops are cereals (mainly wheat, barley, rye and triticale), soybeans, bananas, rice, coffee, turnips, red and sugar beets.

The chemical formula of epoxiconazole corresponds to the following:

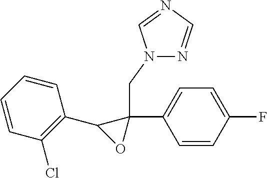 [SMILES: Fc1ccc(C2(Cn3cncn3)OC2c2ccccc2Cl)cc1]

It is common to find propiconazole fungicide marketed in the agrochemical market as an 25% w/v Emulsifiable Concentrate (EC) (for example: ADAMA ESSENTIALS BUMPER 25, Propiconazole Dow AgroSciences, PROPICONAZOL 250 EC from Agrospec®, HELD 250 EC, etc.).

Propiconanol corresponds to the chemical compound 1-[[2-[[2-(2,4-dichlorophenyl)-4-propyl-1,3-dioxolan-2-yl]methyl]-1,2,4-triazole of chemical formula:

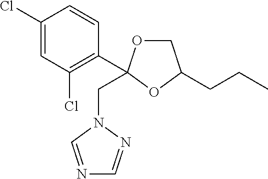 [SMILES: CCCC1COC(Cn2cncn2)(c2ccc(Cl)cc2Cl)O1]

Among the methoxyacrylates, compounds such as the strobilurins are selected from the group comprising azoxystrobin, Picoxystrobin and Trifloxystrobin.

Azoxystrobin is a broad-spectrum systemic fungicide widely used in agriculture to protect crops from fungal diseases. It was first marketed in 1996 under the brand name Amistar and by 1999 had been registered in 48 countries on more than 50 crops.

Azoxystrobin corresponds to the compound with the following chemical structure:

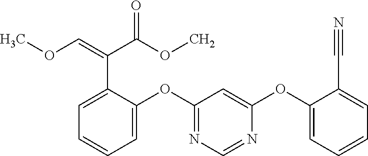 [SMILES: CO/C=C(/C(=O)OC)c1ccccc1Oc1cc(Oc2ccccc2C#N)ncn1]

As with other strobilurin analogs, picoxystrobin inhibits fungal respiration and has both preventive and curative properties, and picoxystrobin has enhanced curative properties compared to azoxystrobin in certain crops.

Picoxystrobin offers virtually complete biokinetics due to its rapid absorption, diffusion in cuticular waxes, translaminar activity, systemic acropetal movement, vapor phase redistribution and protection of newly formed organs, which allows very uniform protection of treated plant tissues during the growth phase of the plant. It has a good resistance to rain washing. It is the most efficient strobilurin.

Picostrobin has the following chemical structure:

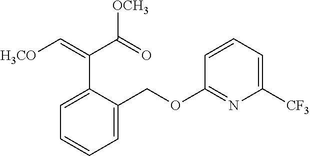 [SMILES: CO/C=C(/C(=O)OC)c1ccccc1COc1cccc(C(F)(F)F)n1]

Trifloxystrobin is particularly active on spore germination and mycelial growth on the plant surface. It also inhibits the development of pathogens, such as the formation of haustoria in the epidermis of plant tissue. Tebuconazole is incorporated into the plant and distributed upward.

Trifloxystrobin has the following chemical formula:

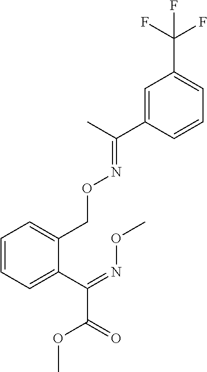 [SMILES: CO/N=C(/C(=O)OC)c1ccccc1CO/N=C(\C)c1cccc(C(F)(F)F)c1]

The Chinese patent application CN102047890 A relates to a sterilization composition with synergistic effect comprising azoxystrobin and epoxiconazole, said application does not contemplate compositions in the form of microemulsion.

The Chinese patent application CN 102405912 A also relates to a composition with synergistic effect comprising azoxystrobin and epoxiconazole, said application does not contemplate compositions in the form of microemulsion.

### SUMMARY

The present composition contemplates a fungicidal composition in microemulsion form comprising a first component selected from the group consisting of triazolinthione and/or triazoles fungicides and a second component selected from the group consisting of methoxyacrylates, wherein the concentration of the first component is in the range of 2.5% w/v to 9.0% w/v and the concentration of the second component is in the range of 3.5% w/v to 10.0% w/v.

The above microemulsion composition further comprises, in addition, a mixture of nonionic surfactants, solvents selected from water soluble solvents and water insoluble solvents, fatty tallow alkyl amine ethoxylated with 10-15 moles of ethylene oxide or coconut alkyl amine ethoxylated with 10-15 moles of ethylene oxide, ethyl sulfosuccinate or dioctyl sulfosuccinate wetting agent, methyl salicylate, Fatty Acid Methyl Esters (FAME), silicone defoamer and water as dispersant.

In the fungicidal composition in microemulsion form the first component selected from the group consisting of triazolinthione fungicides and/or triazoles are selected from prothioconazole, epoxiconazole, and tebuconazole.

In the fungicidal composition in microemulsion form, the second component selected from the group consisting of methoxyacrylates is selected from picoxystrobin, azoxystrobin, and trifloxystrobin.

In the fungicidal composition in microemulsion form the nonionic and/or anionic surfactants are selected from Noniphenol of 10 moles EO, Alcohol (C12-C15) ethoxylated with 7 moles EO Dilute, a block copolymer surfactant is an alkoxylate such as, for example, an ethylene oxide/propylene oxide block copolymer initiated with alcohol such as an ethylene oxide/propylene oxide block copolymer initiated with 4-butoxy-iso-butanol, and mixtures thereof.

In the fungicidal composition in microemulsion form the total amount of nonionic surfactants ranges from 9.85 to 25% w/v.

In the fungicidal composition in microemulsion form the total amount of fatty tallow alkyl amine ethoxylated with 10-15 moles of ethylene oxide or coconut alkyl amine ethoxylated with 10-15 moles of ethylene oxide in the composition ranges from 3.21 to 10% w/v.

In the fungicidal composition in microemulsion form the water soluble solvents are selected from N-methylpyrrolidone, cyclohexanone, dimethyl sulfoxide (DMSO) or mixtures thereof.

In the fungicidal composition in microemulsion form the water insoluble solvent is selected from toluene.

In the fungicidal composition in microemulsion form the total amount of wetting agent Ethyl Sulfosuccinate or Dioctyl Sulfosuccinate or Sodium Dioctyl Sulfosuccinate in the composition ranges from 2.48 to 10.0% w/v.

In the fungicidal composition in microemulsion form the total amount of methyl salicylate in the composition ranges from 5.78 to 15.0% w/v.

In the fungicidal composition in the form of microemulsion the total amount of water in the composition ranges from 1 to 58% w/v.

The fungicidal composition in microemulsion form is selected from a composition comprising the following components: picoxystrobin 7.5% w/v, prothioconazole 6.5% w/v, N-methylpyrrolidone 21.0% w/v, methyl salicylate 13.5% w/v, nonylphenol ethoxylated with 10 moles of EO 13.5% w/v, ethylene oxide/propylene oxide block copolymer surfactant initiated with 4-butoxy-iso-butane 9.5% w/v, wetting agent based on ethyl sulfosuccinate or dioctyl sulfosuccinate or the sodium dioctyl sulfosuccinate salt thereof 5.8% w/v, formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 16.5% w/v, fatty acid methyl esters 3.0% w/v, water 2.0% w/v and silicone defoamer 0.01% w/v.

The fungicidal composition in microemulsion form is selected from a composition comprising the following components: picoxystrobin 7.5% w/v, prothioconazole 6.5% w/v, N-methylpyrrolidone 21.0% w/v, methyl salicylate 13.5% w/v, Alcohol (C12-C15) ethoxylated with 7 moles EO diluted 13.5% w/v, ethylene oxide/propylene oxide block copolymer surfactant initiated with 4-butoxy-iso-butane 9.5% w/v, wetting agent based on ethyl sulfosuccinate or dioctyl sulfosuccinate or the sodium dioctyl sulfosuccinate salt thereof 5.8% w/v, formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 16.5% w/v, fatty acid methyl esters 3.0% w/v, water 2.0% w/v and silicone defoamer 0.01% w/v.

The fungicidal composition in microemulsion form is selected from a composition comprising the following components: picoxystrobin 7.5% w/v, prothioconazole 6.5% w/v, Dimethyl sulfoxide (DMSO) 11.0% w/v, methyl salicylate 13.0% w/v, nonylphenol ethoxylated with 10 moles of EO or alcohol (C12-C15) ethoxylated with 7 moles EO diluted 13.5% w/v, ethylene oxide/propylene oxide block copolymer surfactant initiated with 4-butoxy-iso-butane 9.5% w/v, wetting agent based on ethyl sulfosuccinate or dioctyl sulfosuccinate or the sodium dioctyl sulfosuccinate salt thereof 5.8% w/v, formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 26.5% w/v, fatty acid methyl esters 3.0% w/v, water 2.0% w/v and silicone defoamer 0.01% w/v.

The fungicidal composition in microemulsion form is selected from a composition comprising the following components: picoxystrobin 3.5% w/v, prothioconazole 2.5% w/v, N-methylpyrrolidone 9.0% w/v, methyl salicylate 5.78% w/v, nonylphenol ethoxylated with 10 moles of EO or alcohol (C12-C15) ethoxylated with 7 moles EO diluted 5.78% w/v, ethylene oxide/propylene oxide block copolymer surfactant initiated with 4-butoxy-iso-butane 4.07% w/v, wetting agent based on ethyl sulfosuccinate or dioctyl sulfosuccinate or the dioctyl sulfosuccinate salt thereof 2.48% w/v, formulation adjuvant composed of selected fatty tallow alkyl amine ethoxylated with 10-15 moles of ethylene oxide or coconut alkyl amine ethoxylated with 10-15 moles of ethylene oxide 3.21% w/v, cyclohexanone 7.06% w/v, fatty acid methyl esters 1.28% w/v, water 58.0% w/v and silicone defoamer 0.01% w/v.

The fungicidal composition in microemulsion form is selected from a composition comprising the following components: picoxystrobin 3.5% w/v, prothioconazole 2.5% w/v, dimethyl sulfoxide (DMSO) 4.71% w/v, methyl salicylate 5.57% w/v, nonylphenol ethoxylated with 10 moles of EO or alcohol (C12-C15) ethoxylated with 7 moles EO diluted 5, 78% w/v, ethylene oxide/propylene oxide block copolymer surfactant initiated with 4-butoxy-iso-butane 4.07% w/v, wetting agent based on ethyl sulfosuccinate or dioctyl sulfosuccinate or the sodium dioctyl sulfosuccinate salt thereof 2.48% w/v, formulation adjuvant composed of selected fatty tallow alkyl amine ethoxylated with 10-15 moles of ethylene oxide or coconut alkyl amine ethoxylated with 10-15 moles of ethylene oxide 3.21% w/v, cyclohexanone 11.34% w/v, fatty acid methyl esters 1.28% w/v, water 58.0% w/v and silicone defoamer 0.01% w/v.

The fungicidal composition in microemulsion form is selected from a composition comprising the following components: picoxystrobin 10.0% w/v, prothioconazole 9.0% w/v, N-methylpyrrolidone 21.0% w/v, methyl salicylate 13.5% w/v, nonylphenol ethoxylated with 10 moles of EO or alcohol (C12-C15) ethoxylated with 7 moles EO diluted 13.5% w/v, ethylene oxide/propylene oxide block copolymer surfactant initiated with 4-butoxy-iso-butane 9.5% w/v, wetting agent based on ethyl sulfosuccinate or dioctyl sulfosuccinate or the sodium dioctyl sulfosuccinate salt thereof 5.8% w/v, formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 16.5% w/v, water 1.0% w/v and silicone defoamer 0.01% w/v.

The fungicidal composition in microemulsion form is selected from a composition comprising the following components: picoxystrobin 10.0% w/v, prothioconazole 9.0% w/v, dimethyl sulfoxide (DMSO) 11.0.0% w/v, methyl salicylate 13.0% w/v, nonylphenol ethoxylated with 10 moles of EO or alcohol (C12-C15) ethoxylated with 7 moles EO diluted 13.5% w/v, ethylene oxide/propylene oxide block copolymer surfactant initiated with 4-butoxy-iso-butane 9.5% w/v, wetting agent based on ethyl sulfosuccinate or dioctyl sulfosuccinate or the sodium dioctyl sulfosuccinate salt thereof 5.8% w/v, formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 26.5% w/v, water 1.0% w/v and silicone defoamer 0.01% w/v.

The fungicidal composition in microemulsion form is selected from a composition comprising the following components: azoxystrobin 7.5% w/v, epoxiconazole 4.5% w/v, N-methylpyrrolidone 22.0% w/v, methyl salicylate 13.75% w/v, nonylphenol ethoxylated with 10 moles of EO 13.5% w/v, ethylene oxide/propylene oxide block copolymer surfactant initiated with 4-butoxy-iso-butane 9.6% w/v, wetting agent based on ethyl sulfosuccinate or dioctyl sulfosuccinate or the sodium dioctyl sulfosuccinate salt thereof 5.9% w/v, formulation adjuvant composed of selected fatty tallow alkyl amine ethoxylated with 10-15 moles of ethylene oxide or coconut alkyl amine ethoxylated with 10-15 moles of ethylene oxide 7.56% w/v, toluene 16.7% w/v, fatty acid methyl esters 2.1% w/v, and water 1.7% w/v.

The fungicidal composition in microemulsion form is selected from a composition comprising the following components: azoxystrobin 7.5% w/v, prothioconazole 6.0% w/v, N-methylpyrrolidone 21.0% w/v, methyl salicylate 13.5% w/v, nonylphenol ethoxylated with 10 moles of EO 13.5% w/v, ethylene oxide/propylene oxide block copolymer surfactant initiated with 4-butoxy-iso-butane 9.5% w/v, wetting agent based on ethyl sulfosuccinate or dioctyl sulfosuccinate or the sodium dioctyl sulfosuccinate salt thereof 5.8% w/v, formulation adjuvant composed of selected fatty tallow alkyl amine ethoxylated with 10-15 moles of ethylene oxide or coco alkyl amine ethoxylated with 10-15 moles of ethylene oxide 7.5% w/v, cyclohexanone 16.5% w/v, fatty acid methyl esters 3.0% w/v, and water 2.0% w/v.

The fungicidal composition in microemulsion form is selected from a composition comprising the following components: azoxystrobin 7.5% w/v, tebuconazole 4.5% w/v, N-methylpyrrolidone 22.0% w/v, methyl salicylate 13.75% w/v, nonylphenol ethoxylated with 10 moles of EO 13.5% w/v, ethylene oxide/propylene oxide block copolymer surfactant initiated with 4-butoxy-iso-butane 9.6% w/v, wetting agent based on ethyl sulfosuccinate or dioctyl sulfosuccinate or the sodium dioctyl sulfosuccinate salt thereof 5.9% w/v, formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 16.7% w/v, fatty acid methyl esters 2.1% w/v, and water 1.7% w/v.

The fungicidal composition in microemulsion form is selected from a composition comprising the following components: trifloxitrobin 7.5% w/v, tebuconazole 4.5% w/v, N-methylpyrrolidone 25.0% w/v, methyl salicylate 15.0% w/v, nonylphenol ethoxylated with 10 moles of EO 15.0% w/v, ethylene oxide/propylene oxide block copolymer surfactant initiated with 4-butoxy-iso-butane 10.0% w/v, wetting agent based on ethyl sulfosuccinate or dioctyl sulfosuccinate or its dioctyl sulfosuccinate sodium salt 10.0% w/v, formulation adjuvant composed of selected fatty tallow alkyl amine ethoxylated with 10-15 moles of ethylene oxide or coconut alkyl amine ethoxylated with 10-15 moles of ethylene oxide 10.0% w/v, fatty acid methyl esters 7.0% w/v, and water 2.0% w/v.

### BRIEF DESCRIPTION OF THE DRAWINGS

FIG. 1 is a graph illustrating the percentage incidence of Septoria glycines observed in soybean test plots over time for untreated controls and for treated compositions at various application rates.

FIG. 2 is a graph showing the corresponding leaf-area severity of Septoria glycines infection for the plots evaluated in FIG. 1.

FIG. 3 is a set of Petri-dish images depicting in-vitro growth inhibition of Drechslera teres at serial dilutions of a microemulsion containing 7.5% azoxystrobin and 6.0% prothioconazole.

FIG. 4 is a set of Petri-dish images depicting in-vitro growth inhibition of Drechslera teres at serial dilutions of a microemulsion containing 7.5% azoxystrobin and 4.5% tebuconazole.

FIG. 5 is a set of Petri-dish images depicting in-vitro growth inhibition of Drechslera teres at serial dilutions of a microemulsion containing 7.5% picoxystrobin and 6.5% prothioconazole.

FIG. 6 is a set of Petri-dish images comparing growth inhibition of Drechslera teres at serial dilutions of a microemulsion containing 7.5% trifloxystrobin and 4.5% tebuconazole with a commercial suspension-concentrate control.

FIG. 7 comprises time-lapse photographs showing the physical stability (absence of phase separation or precipitate) of a trifloxystrobin/tebuconazole microemulsion and a commercial suspension concentrate after 0, 30, and 120 minutes in 1000-ppm hard water.

FIG. 8 comprises time-lapse photographs showing the physical stability of an azoxystrobin/epoxiconazole microemulsion and a commercial suspension concentrate under the same conditions depicted in FIG. 7.

FIG. 9 is a particle-size distribution plot obtained by dynamic light scattering, demonstrating that the microemulsion of Example 1 exhibits a mean droplet diameter of approximately 18 nm.

### DETAILED DESCRIPTION

The present disclosure refers to the combination of a triazolinthione and/or triazoles, and a methoxyacrylate. Preferably, among the triazolinthiones we can mention as examples prothioconazole, epoxyconazole, propioconazole, among others, and on the other hand methoxyacrylates such as the strobilurins selected from the group comprising azoxystrobin and picoxystrobin for obtaining fungicidal compositions in the microemulsion form.

In one embodiment, the present disclosure relates to a composition in microemulsion form comprising a triazolintoin and a strobilurin selected from the group comprising azoxystrobin and picoxystrobin.

In another embodiment, the microemulsion formulation of the present composition comprises a strobilurin, preferably azoxystrobin and a triazole, selected from the group comprising tebuconazole, epoxyconazole.

In another embodiment, the mciroemulsion formulation of the present composition comprises a strobilurin, preferably azoxystrobin, and prothioconazole.

Mixtures formed by the combination of a triazolinthione and/or triazoles, and a methoxyacrylate, preferably a strobilurin, simultaneously, or separately, are characterized by an excellent effect against a broad spectrum of phytopathogenic fungi, especially of the class of ascomycetes, basidiomycetes, phycomycetes and deuteromycetes. In part they have a systemic effect and can therefore also be used as leaf and soil fungicides.

They have a special significance in the control of a plurality of fungi on various crop plants such as cotton, vegetables (e.g. cucumbers, beans, tomatoes, potatoes and cucurbit crops), barley, grass, oats, bananas, coffee, corn, fruit trees, rice, rye, soybeans, grapevine, wheat, ornamentals, sugar cane and a plurality of seeds.

They are especially suitable for the control of the following phytopathogenic fungi: Blumeria graminis (downy mildew) on cereals, Erysiphe cichoracearum and Sphaerotheca fuliginea on cucurbit crops, Podosphaera leucotricha on apple trees, Uncinula necator on grapevines, Puccinia types on cereals, Rhizoctonia types on cotton, rice and grasses, Ustilago types on cereals and sugarcane, Venturia inaequalis (anthracnose) on apple trees, Helminthosporium types on cereals, Septoria nodorum on wheat, Septoria glycines on wheat, Botrytis cinera (gray mold) on strawberries, vegetables, ornamentals and vines, Cercospora arachidicola on peanuts, Pseudocercosporella herpotrichoides on wheat and barley, Pyricularia oryzae on rice, Phytophthora infestans on potatoes and tomatoes, Plasmopara viticola on grapevines, Pseudoperospora types on hops and cucumbers, Alternaria types on vegetables and fruit trees, Mycosphaerella types on bananas as well as Fusarium and Verticillium types.

They can also be used as protection of materials (e.g. wood protection), e.g. against Paecilomyces variotii.

Fungicide compositions in microemulsion form are formulations containing emulsified oily droplets of very small size resulting in a transparent formulation that is thermodynamically stable over a wide temperature range because the droplets have a very small size varying in the range of 0.01 μm to 0.05 μm in diameter.

Therefore, unlike other emulsion systems, where over time the oily droplets can slowly coalesce causing phase separation, this does not happen in microemulsion formulations.

Microemulsions consist of immiscible liquids and appropriate amounts of surfactant and co-surfactant.

The additional components used in microemulsion formulations are essential depending on the type of active ingredient used to achieve a transparent formulation.

Also important is the form of preparation thereof depending on the solubility of each of the active components.

The present disclosure is directed to binary fungicidal compositions contemplating the combination of a triazolinthione and/or triazoles, and a methoxyacrylate, preferably a strobilurin, in the form of a microemulsion.

Examples of the fungicidal compositions in microemulsion form include the following:

In another embodiment, the fungicidal formulation in microemulsion form of the present composition comprises a strobilurin, preferably azoxystrobin, and prothioconazole.

### Components:

Solvents: water miscible: cyclohexanone, N-methylpyrrolidone, DMSO.

N-methylpyrrolidone is a water-soluble aprotic dipolar organic solvent.

Immiscible in water: Toluene

It has been found that the mixture DMSO (dimethyl sulfoxide) and CYCLOHEXANONE can be used as a replacement for N-methylpyrrolidone.

Surfactants (anionic/non-ionic surfactants/surfactants)/emulsifiers:

Nonionic Surfactants: 10 mole EO Noniphenol, Alcohol (C12-C15) ethoxylated with 7 moles of diluted EO (i.e. MERACOL NFS: Nonionic Surfactant, equivalent to 10MOE Nonylphenol), Atlas G 5002L, 15 moles EO Coconut or Ethoxylated Coconut Alkyl Amine, Ethoxylated Fatty Tallow Amine with 15 moles ethoxylated ethylene oxide.

Anionic surfactants: e.g. sodium dioctyl sulfosuccinate, e.g. B70 from Clariant.

Clarification: 15 moles EO ethoxylated coconut amine would act as solvent and surfactant.

Dispersant: Water.

Others: Fatty Acid Methyl Esters (FAMEs)

Another suitable example of a block copolymer surfactant is an alkoxylate such as, for example, an alcohol-initiated ethylene oxide/propylene oxide block copolymer such as an ethylene oxide/propylene oxide block copolymer initiated with 4-butoxy-iso-butanol (CAS number 99821-01-9) of which Atlas™ G5000 and Atlas™ G5002L are examples, and which are available from Croda (Edison, N.J.). Atlas™ G5000 and Atlas™ G5002L are butyl block copolymers having an HLB of 17.

Atlas G5002L is a non-ionic surfactant.

As wetting agent it is preferred those based on Ethyl Sulfosuccinate or Dioctyl Sulfosuccinate or the dioctyl sodium sulfosuccinate salt thereof, such as those provided by Clariant® corresponding to Wetting Agent B 70.

Selected compounds of fatty tallow alkyl amine ethoxylate with 10-15 moles of ethylene oxide known as Genamin® T 150 or coconut fatty amine ethoxylate with 10-15 moles of ethylene oxide (Coconut fatty amine ethoxylate with 15 mol EO) known as Genamin® C 150 are used as formulation adjuvant, wherein the alkyl portion is composed of saturated C8-C18 chains, predominantly C12-C14.

FAME (Fatty acid methyl esters),

Fatty acid methyl esters (FAME) are a type of fatty acid esters obtained by alkali-catalyzed transesterification of fats or oils with methanol. Those from soybean vegetable fatty acids are preferred. It is marketed as a fatty acid esterification product of soybean oil and its main use is as an adjuvant in agricultural products.

In addition, fatty acid methyl esters such as soybean oil (FAME) are used as coadjuvants; coadjuvants give them an anti-evaporating and adherent power to agricultural applications; this property is essential to avoid the separation of the active phases in the mixing tank at the time of application of agrochemicals.

In our case, FAME is used as a solvent.

Methyl salicylate is an agrochemical compound that reduces plant stress; however, in the present formulation it is used as a solvent/stabilizer.

Silicone is especially effective in controlling foam; both in defoamers, which prevent foam formation, and in foam control agents, which minimize foam formation. Silicone defoamer is added in the present formulation.

The formulation of the present composition, in the form of microemulsion with particle size of the order of 19 nanometers (0.019 μm), allows a reduction in the concentration of fungicides (grams of total active ingredients) applied per hectare, this is achieved given the reduction in particle size which allows an increase in the contact surface between the active ingredients of the formulation and the target pathogen; this is achieved without affecting the yield of the treated crops, achieving less defoliation (toxicity on the plant), reducing the environmental impact and the generation of residues of products that do not act on the target pathogen. On the other hand, the present composition allows a more uniform spraying of the fungicide at the time of application due to the stability of the product in the application broths, allowing the formulation to remain homogeneously dispersed in the broth for a longer time compared to other types of formulations commercially available in the state of the art.

### EXAMPLES

In order to illustrate different details and aspects of the present disclosure, various examples are set forth, without implying any limitation to the scope of the present composition.

### Embodiment Example 1

| Fungicide composition ME of Picoxystrobin | |
|---|---|
| 7.5% + Prothioconazole 6.5%. | % w/v |
| Picoxystrobin GT | 7.80 |
| Prothiocoazole GT | 6.80 |
| N-methylpyrrolidone | 21.00 |
| Methyl salicylate | 13.50 |
| 10 EO Nonylphenol | 13.50 |
| Atlas G 5002L | 9.50 |
| B 70 Clariant | 5.80 |
| Genamin ® T150 | 7.50 |
| Cyclohexanone | 16.50 |
| FAME | 3.00 |
| Water | 2.00 |
| Defoamer | 0.01 |

### Preparation Method of Example 1

### Step 1

In a first container (container 1), container 1, the mentioned quantities for 100 ml of formulation are added in the following order: N-methylpyrrolidone, cyclohexanone, methyl salicylate; stirring until complete homogenization of the solution.

### Step 2

The active ingredient, strobilurin, e.g. Picoxystrobin GT, is added under agitation to container 1 and stirred until complete solubilization, then the triazole or triazolianthoin, e.g. Prothioconazole GT, is added under agitation and the solution is stirred until complete solubilization.

### Step 3

In a second container (container 2), the following compounds are added in the following order: 15 mol EO ethoxylated coconut amine, 10 EO Nonylphenol (or Meracol NFS), B 70 (Clariant), Atlas G 5002L, and stir until complete homogenization.

### Step 4

To container 1 add the contents of container 2 under agitation until complete homogenization, add silicone defoamer under continuous agitation (2500 rpm for 30′), then add FAME (if needed) and water.

### Embodiments Examples 2 and 3

ME Fungicide Composition of Picoxystrobin

| 7.5% + Prothioconazole 6.5%. | Concentration % w/v | |
|---|---|---|
| Picoxystrobin GT (96% Purity) | 7.80 | 7.80 |
| Prothiocoazole GT (96% Purity) | 6.80 | 6.80 |
| N-methylpyrrolidone | 21.00 | 21.00 |
| Methyl salicylate | 13.50 | 13.50 |
| 10 EO Nonylphenol | 13.50 | 0 |
| MERACOL NFS (Alcohol (C12-C15) | 0 | 13.50 |
| ethoxylated with 7 moles of EO Diluted) | | |
| Atlas G 5002L | 9.50 | 9.50 |
| B 70 Clariant | 5.80 | 5.80 |
| 15 mole ethoxylated coconut | 7.50 | 7.50 |
| amine EOGenamin ® C150 | | |
| Cyclohexanone | 16.50 | 16.50 |
| FAME | 3.00 | 3.00 |
| Water | 2.00 | 2.00 |
| Defoamer | 0.01 | 0.01 |

Different concentration ranges of Picoxystrobin and Prothioconazole were also prepared so as to obtain stable microemulsion fungicide compositions; the same are summarized below in Examples 4, 5, 6, 7, 8 and 9:

| Picoxystrobin 7.5% + | | |
|---|---|---|
| Prothioconazole 6.5%. | % w/v | % w/w |
| Picoxystrobin GT 97% | 7.73 | 7.24 |
| Prothioconazole GT 97% | 6.70 | 6.28 |
| N-methylpyrrolidone | 21.00 | 19.67 |
| Methyl salicylate | 13.50 | 12.65 |
| 10 EO Nonylphenol | | |
| MERACOL NFS | 13.50 | 12.65 |
| Atlas G 5002L | 9.50 | 8.90 |
| B 70 Clariant | 5.80 | 5.43 |
| 15 mole ethoxylated coconut | 7.50 | 7.03 |
| amine | | |
| Cyclohexanone | 16.50 | 15.46 |
| FAME | 3.00 | 2.81 |
| Defoamer | 0.01 | 0.01 |
| Water | 2.00 | 1.87 |
| Picoxystrobin GT 97% | 7.73 | 7.24 |
| Prothioconazole GT 97% | 6.70 | 6.28 |
| N-methylpyrrolidone | 11.00 | 10.31 |
| Methyl salicylate | 13.00 | 12.18 |
| 10 EO Nonylphenol | 13.50 | 12.65 |
| MERACOL NFS | | |
| Atlas G 5002L | 9.50 | 8.90 |
| B 70 Clariant | 5.80 | 5.43 |
| 15 mole ethoxylated coconut | 7.50 | 7.03 |
| amine | | |
| Cyclohexanone | 26.50 | 24.83 |
| FAME | 3.00 | 2.81 |
| Defoamer | 0.01 | 0.01 |
| Water | 2.00 | 1.87 |
| | 106.24 | |
| Picoxystrobin 3.5% + | | |
| Prothioconazole 2.5%. | % w/v | % w/w |
| Picoxystrobin GT 97% | 3.60 | 3.50 |
| Prothioconazole GT 97% | 2.60 | 2.53 |
| N-methylpyrrolidone | 9.00 | 8.75 |
| Methyl salicylate | 5.78 | 5.62 |
| 10 EO Nonylphenol | 5.78 | 5.62 |
| MERACOL NFS | | |
| Atlas G 5002L | 4.07 | 3.95 |
| B 70 Clariant | 2.48 | 2.41 |
| 15 mole ethoxylated coconut | 3.21 | 3.12 |
| amine | | |
| Cyclohexanone | 7.06 | 6.87 |
| FAME | 1.28 | 1.25 |
| Defoamer | 0.01 | 0.01 |
| Water | 58.00 | 56.38 |
| | 102.88 | |
| Picoxystrobin GT 97% | 3.60 | 3.50 |
| Prothioconazole GT 97% | 2.60 | 2.53 |
| N-methylpyrrolidone | 4.71 | 4.58 |
| Methyl salicylate | 5.57 | 5.41 |
| 10 EO Nonylphenol | 5.78 | 5.62 |
| MERACOL NFS | | |
| Atlas G 5002L | 4.07 | 3.95 |
| B 70 Clariant | 2.48 | 2.41 |
| 15 mole ethoxylated coconut | 3.21 | 3.12 |
| amine | | |
| Cyclohexanone | 11.34 | 11.03 |
| FAME | 1.28 | 1.25 |
| Defoamer | 0.01 | 0.01 |
| Water | 58.00 | 56.38 |
| | 102.65 | |
| Picoxystrobin 10.0% + | | |
| Prothioconazole 9.0%. | % w/v | % w/w |
| Picoxystrobin GT 97% | 10.30 | 9.54 |
| Prothioconazole GT 97% | 9.30 | 8.62 |
| N-methylpyrrolidone | 21.00 | 19.46 |
| Methyl salicylate | 13.50 | 12.51 |
| 10 EO Nonylphenol | 13.50 | 12.51 |
| MERACOL NFS | | |
| Atlas G 5002L | 9.50 | 8.80 |
| B 70 Clariant | 5.80 | 5.37 |
| 15 mole ethoxylated coconut | 7.50 | 6.95 |
| amine | | |
| Cyclohexanone | 16.50 | 15.29 |
| FAME | 0.00 | 0.00 |
| Defoamer | 0.01 | 0.01 |
| Water | 1.00 | 0.93 |
| | 107.91 | |
| Picoxystrobin GT 97% | 10.30 | 9.54 |
| Prothioconazole GT 97% | 9.30 | 8.62 |
| N-methylpyrrolidone | 11.00 | 10.19 |
| Methyl salicylate | 13.00 | 12.05 |
| 10 EO Nonylphenol | 13.50 | 12.51 |
| MERACOL NFS | | |
| Atlas G 5002L | 9.50 | 8.80 |
| B 70 Clariant | 5.80 | 5.37 |
| 15 mole ethoxylated coconut | 7.50 | 6.95 |
| amine | | |
| Cyclohexanone | 26.50 | 24.56 |
| FAME | 0.00 | 0.00 |
| Defoamer | 0.01 | 0.01 |
| Water | 1.00 | 0.93 |
| | 107.41 | |

In the two previous examples, they are also formulated without the use of N-methylpyrrolidone which is replaced by the addition of DMSO and an increase in the concentration of cyclohexanone.

### Example 10: Alternative Formulations: With Azoxystrobin and Epoxiconazole

| ME Fungicide Composition of azoxystrobin | |
|---|---|
| 7.5% w/v + Epoxiconazole 4.5% w/v | % w/v |
| Azoxystrobin GT | 7.70 |
| Epoxiconazole GT | 4.70 |
| N-methylpyrrolidone | 22.00 |
| Methyl salicylate | 13.75 |
| Nonylphenol 10 EO | 13.50 |
| Atlas G 5002L | 9.60 |
| B 70 Clariant | 5.90 |
| Genamin ® T150 | 7.56 |
| Toluene | 16.70 |
| FAME | 2.10 |
| Water | 1.70 |

### Example 11: Alternative Formulations: With Azoxystrobin and Prothioconazole

| ME Fungicide Composition of azoxystrobin | |
|---|---|
| 7.5% w/v + Proticonazole 6.0 w/v | % w/v |
| Azoxystrobin GT | 7.70 |
| Prothiocoazole GT | 6.20 |
| N-methylpyrrolidone | 21.00 |
| Methyl salicylate | 13.50 |
| Nonylphenol 10 EO | 13.50 |
| Atlas G 5002L | 9.50 |
| B 70 Clariant | 5.80 |
| Genamin ® T150 (***) | 7.50 |
| Cyclohexanone | 16.50 |
| FAME | 3.00 |
| Water | 2.00 |
| | 106.20 |

### Example 12: Alternative Formulations: With Azoxystrobin and Tebuconazole

| ME Fungicide Composition of azoxystrobin | Concentration |
|---|---|
| 7.5% w/v + tebuconazole 4.5% w/v | % w/v) |
| Azoxystrobin GT | 7.70 |
| Tebuconazole GT | 4.70 |
| N-methylpyrrolidone | 22.00 |
| Methyl salicylate | 13.75 |
| Nonylphenol 10 EO | 13.50 |
| Atlas G 5002L | 9.60 |
| B 70 Clariant | 5.90 |
| Genamin ® T150 (***) | 7.56 |
| Toluene | 16.70 |
| FAME | 2.10 |
| Water | 1.70 |

### Example 13

| Fungicide composition ME of trifloxitrobin | |
|---|---|
| 7.5% + tebuconazole 4.5%. | % w/v |
| Trifloxitrobin | 7.6 |
| Tebuconazole 97%. | 4.6 |
| NmethylPyrrolidone | 25.0 |
| Methyl salicylate | 15.0 |
| 10 mole ethoxylated nonyl phenol | 15.0 |
| Atlas G5002 L | 10.0 |
| Humectant B 70 | 10.0 |
| Tallow amine ethoxylate 15 EO (Genamin ® | 10.0 |
| T150) | |
| FAME | 7.0 |
| water | 2.0 |

(***) the T150 can be replaced by ethoxylated coconut amine of 15 moles EO

### Example 14: Stability Testing of the Microemulsion

Stability tests were made according to CIPAC MT 46 (adapted to microemulsions) of the formulation prepared according to the above examples, wherein the following stability features are observed:

It is left 30 minutes more without disturbance to analyze and save the volume if free oil, foam, cream or solid matters appear.

ADAPTATION CIPAC METHOD MT 46 (CIPAC Manual F: Accelerated Storage Procedure):

### Introduction to the Method:

The microemulsion is stored in a screw-capped bottle in the stove at a certain temperature and time.

Equipment Thermostatically controlled oven at the set temperature of 54° C.+2° C.

125 ml glass bottles with screw cap with polyethylene insert.

### Procedure

Put the microemulsion (about 100 ml) in the bottle, place the polyethylene insert, and leave it in the stove uncapped, after the bottle has been for half an hour, cap the bottle, and allow it to remain for a specific time of 2 weeks. At the end of the time, remove the bottle from the stove and allow it to come to room temperature naturally, then remove the cap.

Perform the corresponding specific tests of the general methods for microemulsions within 24 hs of cooling. Preparation of the present example:

The fungicidal composition of the present disclosure, in its embodiment, detailed in the above examples, is emulsified in water, by means of tube inversion, as indicated by the cited standards. These tests of emulsion formation and determination of its stability and quality were carried out in containers to which water was added up to 60 ml.

Table of results: stability results of the formulations of the present composition, it is observed that there is no loss of the active ingredients during the stability tests.

| | | | Concentration |
|---|---|---|---|
| | | Initial | degradation |
| | | concentration | 54° % w/v |
| Formulated | | % w/v | after 2 weeks |
| Picoxystrobin + | 7.5 + 6.5 | 7.49/6.51 | 7.50/6.44 |
| Prothioconazole | | | |
| Azoxystrobin + | 7.5 + 4.5 | 7.53/4.55 | 7.48/4.48 |
| Epoxy-Nazole | | | |
| Azoxystrobin + | 7.5 + 6 | 7.53/6.2 | 7.48/6.19 |
| Proticonazole | | | |
| Azoxystrobin + | 7.5 + 4.5 | 7.5/4.53 | 7.48/4.49 |
| Tebuconazole | | | |
| Trifloxystrobin + | 7.5 + 4.5 | 7.53/4.50 | 7.45/4.48 |
| Tebuconazole | | | |

### Example 15: Control Tests were Carried Out on the Different Fungicide Compositions Obtained in Order to Evaluate their Inventive Activity

### Test 1:

“Evaluation of foliar fungicides (picoxystrobin+prothioconazole), in the control of Septoria glycines and its impact on soybean crop productivity”.

The objective was to evaluate the efficacy of different foliar fungicide treatments in the control of Septoria glycines and their effect on soybean crop yield. The test was conducted in the rural area of Irigoyen, in the province of Santa Fe.

The protocol was proposed by Surcos, the products were supplied by the same company and the treatments evaluated are described in the following table:

| | Treatment | Formulation | Dose (cc/ha) |
|---|---|---|---|
| 1 | Absolute control | — | — |
| 2 | picoxystrobin + | ME 7.5% + | 200 |
| | prothioconazole | 6.5% | |
| 3 | picoxystrobin + | ME 7.5% + | 300 |
| | prothioconazole | 6.5% | |
| 4 | picoxystrobin + | ME 7.5% + | 400 |
| | prothioconazole | 6.5% | |
| 5 | picoxystrobin + | ME 7.5% + | 500 |
| | prothioconazole | 6.5% | |
| 6 | picoxystrobin + | ME 7.5% + | 600 |
| | prothioconazole | 6.5% | |
| 7 | picoxystrobin + | SC 20% + 8% | 300 |
| | ciproconazole | | |
| 8 | trifloxistrobin + | SC 15% + | 400 |
| | prothioconazole | 17.5% | |

The experiment was conducted with a soybean crop variety SPS 4×4, planted on Nov. 20, 2021. It was planted with a row spacing of 42 cm and with soybean stubble as a predecessor crop. A completely randomized block experimental design (CRBD) was used with eight treatments and four replications of each. An absolute control, without spraying, was included among the treatments to evaluate the response of the treatments. The experimental unit corresponded to a plot of 3 m in front and 8 m long. At the time of application, the crop was at phenological stage R4 and environmental conditions were favorable. At this time, Septoria glycines pathology was observed, with an incidence of 16.5% in plant height and an average severity of 5.9%.

Spraying was carried out with an experimental backpack with a side boom. The equipment had a working width of 3 m and Magno jet (110 015) hollow cone tablets were used. The pressure source was constant, with compressed CO2 and the working pressure was 40 lb/pg2. An application rate equivalent to 100 l/ha was used.

To evaluate the response of the treatments, Septoria glycines incidence and severity measurements were made. Observations were made at 0, 21 and 36 DDA. Incidence was evaluated as percentage of height affected by the disease and severity as percentage of leaf area affected. With the severity data, the area under the disease progress curve (ABCPE) was constructed and the control efficacy of each treatment was calculated. At the same time, severity assessments were carried out on individual leaflets. For this variable, 10 leaflets were extracted at random per plot from the middle layer of the crop and the percentage of leaf damage was quantified.

At the end of the cycle and crop drying, yield was measured by harvesting 4 m of the 2 central furrows of each plot. The plants were cut at the base with a hedge trimmer and threshed with a static threshing machine with an internal combustion engine. The threshed grain was weighed with a 5-gram precision balance. Percent moisture and hectoliter weight were calculated with a portable grain moisture meter. The weight was corrected for moisture and converted to yield in kg/ha, with a moisture content of 13.5%. Grain weight was also determined in g per thousand seeds, taking 4 samples from each treatment.

Analysis of variance was performed with the Scott&Knott test to differentiate the treatments into groups with similar behavior. The InfoStat program was used and the proposed significance level was 5% (α=0.05). (Source: InfoStat software. Version 2020. InfoStat Group, F.C.A. National University of Córdoba, Argentina).

After the incidence and severity evaluation trial, it is observed that the treatment with the formulation of the present composition (Picoxy7.5%+Prothio 6.5%, ME) shows a control over the incidence, equivalent to the commercial controls used at the recommended doses of marbete (Cripton®, from Bayer and Stinger®, from Corteva).

### Results:

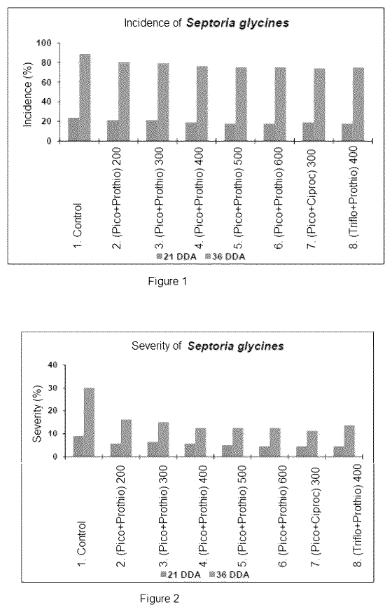

Disease evaluations in the different treatments, see Table below and FIG. 1:

Incidence of Septoria glycines

| | 21 DDA | 36 DDA |
|---|---|---|
| | F = 2.26, | F = 6.8, |
| Treatment | p = 0.067 | p = 0.002 |
| 1. Control | 23.8 a | 88.8 a |
| 2. (Pico + Prothio) 200 | 21.3 a | 80.0 b |
| 3. (Pico + Prothio) 300 | 21.3 a | 78.8 b |
| 4. (Pico + Prothio) 400 | 18.8 b | 76.3 b |
| 5. (Pico + Prothio) 500 | 17.5 b | 75.0 b |
| 6. (Pico + Prothio) 600 | 17.5 b | 75.0 b |
| 7. (Pico + Ciproc) 300 | 18.8 b | 73.8 b |
| 8. (Troflo + Prothio) 400 | 17.5 b | 75.0 b |

Means with a common letter are not significantly different (p > 0.05)

Regarding incidence, it is observed, for example, that at 36 days the treatment 5 of the present composition is compared with the commercial control treatments. When comparing the total concentrations of active ingredients used (doses in gr/ha of the sum of the mixture of strobilurin+triazole) in the formulation of the composition and the control Critpon® (Trifloxystrobin 15%+Prothioconazole 17, 5%, SC) or the control Stinger® (Picoxystrobin 20%+Ciproconazole 8%, SC), it is observed that the formulation of the present composition achieves a control in the incidence of Septoria glycines is equivalent to the controls using doses of i. a. doses of between 17 to 46% less with respect to the products of proven efficacy.

Incidence of Septoria Glycines

| | | | | | | | | Commercial | | |
|---|---|---|---|---|---|---|---|---|---|---|
| | | | | | | | | control | | |
| | | | | Commercial control | | | | (Corteva's | | |
| | Formulation of the | | | (BAYER's Cripton ®) | | | | Stinger ®) | | |
| Dose | composition | | | Dose | | | | Dose | | |
| ml/ha | Picoxi | Prothio | ratio | ml/ha | Trifloxi | Prothio | ratio | ml/ha | Picoxi | Cipro |
| | 7.5 | 6.5 | 0.9 | | 15 | 17.5 | 1.2 | | 20 | 8 |
| 500 | 37.5 | 32.5 | | 400 | 60 | 70 | | 300 | 60 | 24 |
| Total | 70 | | | Total | 130 | | | Total | 84 | |
| AI | | | | AI | | | | AI | | |
| % red | 0 | | | | 46.2 | | | | 16.7 | |
| % red | 0 | 0 | | | | 53.6 | | | 37.5 | |

However, when the severity of infection against the same pathogen, Septoria glycines, is evaluated (see Table below and FIG. 2):

Severity of Septoria glycines

| | 21 DDA | 36 DDA |
|---|---|---|
| | F = 6.7; | F = 18.8; |
| Treatment | p = 0.0002 | p < 0.0001 |
| 1. Control | 9.0 a | 30.0 a |
| 2. (Pico + Prothio 200) | 5.8 b | 16.3 b |
| 3. (Pico + Prothio 300) | 6.5 b | 15.0 b |
| 4. (Pico + Prothio 400) | 5.8 b | 12.5 b |
| 5. (Pico + Prothio 500) | 5.0 b | 12.5 b |
| 6. (Pico + Prothio 600) | 4.5 b | 12.5 b |
| 7. (Pico + Ciproc 300) | 4.5 b | 11.3 b |
| 8. (Triflo + Prothio 400) | 4.5 b | 13.8 b |

Means with a common letter are not significantly different (p > 0.05)

Again it is observed that the formulation of the present composition achieves a performance equivalent to the commercial cores mentioned above. In this case it is observed that treatment 4 (which corresponds to the formulation of the present disclosure) presents an efficacy in the reduction of severity compared to the commercial controls. In this case with a reduction between 33 and 57% about of the total active ingredient of the dose in g/ha (the sum of the mixture of strobilurin+triazole). Thus, for the same effect, it is seen that the amount of active ingredients needed is less for the formulation of the composition. Moreover, if we observe in this case, we see that the reduction of active ingredient on triazolinthione (protoconazole) of the triazole group is about 63%, in the case of the comparison with Cripton®, due to the fact that in the composition of the commercial control it is in a different proportion than in the formulation of the present composition. For the same technical effect, a greater reduction is observed than that found when adding all the AIs of the formulation. This is due to a better effect of the formulation of the composition compared to the commercial control. And when observing the reduction of strobilurin, it is observed that the reduction of active is about 50%, due to the fact that in the composition of the commercial control, Stinger® is found in a different proportion to that of the present composition. For the same technical effect, a greater reduction is observed than that found when all the AI of the formulation are added together. This, again, is due to a better effect of the formulation of the composition compared to the commercial control.

Severity of Septoria Glycines

| | | | | Commercial | | | Commercial | |
|---|---|---|---|---|---|---|---|---|
| Formulation of the | | | | control | | | control | |
| composition | | | | (BAYER'S | | | (Corteva's | |
| Dose | | | Dose | Cripton ®) | | Dose | Stinger ®) | |
| ml/ha | Picoxi | Prothio | ml/ha | Trifloxi | Prothio | ml/ha | Picoxi | Cipro |
| | 7.5 | 6.5 | | 15 | 17.5 | | 20 | 8 |
| 400 | 30 | 26 | 400 | 60 | 70 | 300 | 60 | 24 |
| Total | 56 | | Total | 130 | | Total | 84 | |
| IA | | | IA | | | IA | | |
| | 0 | | | 56.9 | | | 33.3 | |
| % red | 0 | 0 | | | 62.9 | | 50 | |

This severity can be analyzed, also as the control achieved where the results are shown in the following table:

Control of Septoria glycines

| | ABCPE | Control (%) |
|---|---|---|
| | F = 15.9; | F = 2.2; |
| Treatment | p = 0.0001 | p < 0.0835 |
| 1. Control | 449.5 a | |
| 2. (Pico + Prothio 200) | 287.3 b | 36.0 b |
| 3. (Pico + Prothio 300) | 291.5 b | 35.1 b |
| 4. (Pico + Prothio 400) | 259.2 b | 42.3 a |
| 5. (Pico + Prothio 500) | 245.7 b | 45.3 a |
| 6. (Pico + Prothio 600) | 236.7 b | 47.3 a |
| 7. (Pico + Ciproc 300) | 227.3 b | 49.4 a |
| 8. (Triflo + Prothio 400) | 246.1 b | 45.2 a |

Means with a common letter are not significantly different (p > 0.05)

In this case, it is again observed that treatments 4 and 5 have a similar performance to the controls, reinforcing that the formulation of the present composition presents an equivalent behavior with lower doses of active ingredients per hectare.

Then, if we analyze the defoliation of the plants, it is observed that there is a lower defoliation of the plants treated with the formulation of the present composition (see Table below):

Defoliation (%)

| | 44 DDA |
|---|---|
| Treatment | F = 1.82; p = 0.131 |
| 1. Control | 76.25 a |
| 2. (Pico + Prothio 200) | 58.75 a |
| 3. (Pico + Prothio 300) | 55 a |
| 4. (Pico + Prothio 400) | 50 a |
| 5. (Pico + Prothio 500) | 50 a |
| 6. (Pico + Prothio 600) | 57.5 a |
| 7. (Pico + Ciproc 300) | 57.5 a |
| 8. (Triflo + Prothio 400) | 60 a |

Means with a common letter are not sig. different (p > 0.05)

With respect to the yield (see table below), in spite of observing a lower value in said value, it is concluded that the treatments carried out with the formulation of the composition are similar without observing significant variations in the yields obtained.

Yield

| | | Hectolitric | Grain weight |
|---|---|---|---|
| | Yield Kg/ha | weight Kg/hl | g/1000 seeds |
| Treatment | F = 0.36; p = 0.92 | F = 1.16; p = 0.362 | F = 1.32; p = 0.179 |
| 1. Control | 3,426.1 a | 68.73 a | 126.58 a |
| 2. (Pico + Prothio | 3,547.2 a | 68.73 a | 127.78 a |
| 200) | | | |
| 3. (Pico + Prothio | 3,697.6 a | 68.63 a | 128.51 a |
| 300) | | | |
| 4. (Pico + Prothio | 3,687.9 a | 69.18 a | 128.43 a |
| 400) | | | |
| 5. (Pico + Prothio | 3,644.9 a | 69.43 a | 130.11 a |
| 500) | | | |
| 6. (Pico + Prothio | 3,741.1 a | 69.20 a | 133.04 a |
| 600) | | | |
| 7. (Pico + Ciproc | 3,775.5 a | 69.45 a | 133.20 a |
| 300) | | | |
| 8. (Triflo + Prothio | 3,727.1 a | 69.43 a | 132.99 a |
| 400) | | | |

Means with a common letter are not significantly different (p > 0.05)

Again it is observed that there are no significant differences in the yields, concluding that the yields are equivalent.

### Example 16: In Vitro Sensitivity—Assays with the Different Combinations of Strobilurins and Triazoles of the Present Composition

The objective of this study is to determine, in in vitro experiments, the inhibitory concentration (IC50) of different fungicides to fungi causing OCD (end-of-cycle diseases). The evaluation of mycelial growth was carried out by incorporating a 0.6 cm agar disc with mycelium of each pathogen in Petri dishes containing glucosated potato agar with different concentrations of the fungicides of 0, 0.01, 0.1, 1, 10, 20 and 40 ppm. The plates were incubated at a temperature of 24° C., with a photoperiod of 12 hs light/12 hs darkness. The mycelial growth diameter was measured in each of the treatments when the mycelium of the fungus reached the edges of the Petri dish in the control treatments without fungicide. In particular, IC tests were carried out on the pathogen Drechslera teres as a representative pathogen causing net blotch with high incidence and also the beginnings of spot-type net blotch in barley.

Preparation of concentrations and seeding of fungi for fungitoxicity tests

Dilutions of increasing concentration (0.01, 0.1, 1, 1, 10, 20 and 40 ppm) were prepared from solutions of the various fungicide formulations of the present composition, in the form of microemulsion: picoxystrobin 7.5%+prothioconazole 6.5% ME, azoxystrobin 7.5% w/v+prothioconazole 6.0 w/v ME, azoxystrobin 7.5% w/v+tebuconazole 4.5% w/v ME, trifloxitrobin 7.5+tebuconazole 4.5 ME, and commercial controls: picoxystrobin 10% w/v+Prothioconazole 11.67% w/v EC, azoxystrobin 16%+prothioconazole 17.5%, SC, azoxystrobin 10%+tebuconazole 8% SC, trifloxitrobin 10+tebuconazole 20 SC.

With the aid of a micropipette, the corresponding aliquot of stock solution was deposited in the APG medium previously cooled to 50° C., stirred, poured into 4 Petri dishes, and waited until solidification, repeating the same procedure with the remaining treatments.

Agar discs containing inoculum of each pathogen under study (Drechslera teres) were seeded in the center of each Petri dish containing the culture medium with the active ingredients under study.

Each active ingredient was analyzed by means of a completely randomized experimental design, in which the experimental unit considered is each Petri dish with APG and its corresponding agar disc, which received the corresponding treatments (0.01, 0.1, 1, 10, 20 and 40 ppm).

After seeding, the plates were incubated at 24° C. with a 12 h light/12 h dark photoperiod.

The diameter of the colonies was measured and the growth inhibition capacity (absence of mycelium) of the different formulations and the indicated concentrations was calculated.

Results of each of the combinations of the present composition:

### 16.a Azoxystrobin+Prothioconazole

The image shows growth inhibition (absence of mycelium) at 1 ppm when using the formulation of the present composition (azoxystrobin 7.5%+prothioconazole 6.0% ME). However, with the commercial control (azoxystrobin 16%+prothioconazole 17.5%, SC) growth is observed at 1 ppm and inhibition at 10 ppm.

The formulation of the present composition presents a total of active ingredients of 13.5 g AIs/100 cc of formulation, corresponding to 55.5% to azoxystrobin and 45.5% to prothioconazole.

The commercial formulation has a total active ingredient content of 33.5 g AIs/100 cc of formulation, corresponding to 47.8% azoxystrobin and 52.2% prothioconazole.

Understanding that the inhibition is clear at 1 ppm for the formulation of the present composition, it is achieved with 0.555 ppm of azoxystrobin and 0.455 ppm of prothioconazole. In the case of the commercial control, the inhibition is clear at 10 ppm, i.e., it is achieved with 4.78 ppm of azoxystrobin and 5.22 ppm of prothioconazole.

These values are much higher compared to the formulation presented.

This results in a significant reduction of both active ingredients for the same effect.

The in vitro sensitivity test result of Drechslera teres to the formulation of the composition (azoxystrobin 7.5%+prothioconazole 6.0% ME) vs commercial control (azoxystrobin 16%+prothioconazole 17.5%, SC)) can be seen in FIG. 3.

### 16.B Azoxystrobin+Tebuconazole

The formulation of the present composition employing azoxystrobin 7.5%+tebuconazole 4.5% ME presents a total active ingredient of 12 g AIs/100 cc of formulated, corresponding 62.5% to azoxystrobin and 37.5% to tebuconazole.

The commercial formulation (azoxystrobin 10%+tebuconazole 8% SC) has a total of 18 g AIs/100 g or cc of formulation, corresponding 55.5% to azoxystrobin and 44.5% to tebuconazole.

Inhibition (absence of mycelium) is clear at 0.1 ppm for the proprietary formulation, achieved with 0.0625 ppm of azoxystrobin and 0.0375 ppm of tebuconazole. In the case of the commercial control, inhibition is clear at 1 ppm, i.e. it is achieved with 0.555 ppm of azoxystrobin and 0.445 ppm of tebuconazole. These values are much higher compared to the formulation presented.

This results in a significant reduction of both actives for the same effect, being almost 9 times lower for azoxystrobin and 12 times lower for tebuconazole.

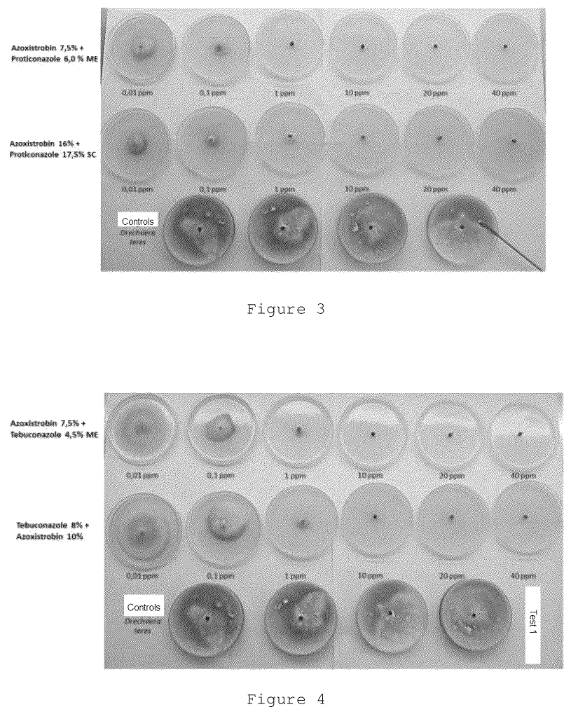

The in vitro sensitivity test result of Drechslera teres to the formulation of the composition (azoxystrobin 7.5%+Tebuconazole 4.5% ME) vs. commercial control (azoxystrobin 10%+tebuconazole 8% SC) can be seen in FIG. 4.

### 16.C Picoxystrobin+Prothioconazole

The formulation of the present composition (picoxystrobin 7.5%+prothioconazole 6.5% ME) presents a total of 14 g AIs/100 cc of formulation, corresponding 53.6% to picoxystrobin and 46.4% to prothioconazole.

The commercial formulation (picoxystrobin 10%+prothioconazole 11.67% EC) shows a total of 21.67 g AIs/100 g or cc of formulation, corresponding 46.1% to picoxystrobin and 53.9% to prothioconazole.

Understanding that inhibition is clear at 1 ppm for the proprietary formulation, it is achieved with 0.536 ppm of picoxystrobin and 0.464 ppm of prothioconazole. In the case of the commercial control, the inhibition is clear at 10 ppm, i.e. it is achieved with 4.61 ppm of picoxystrobin and 5.39 ppm of prothioconazole. These values are much higher compared to the formulation presented.

This results in a significant reduction of both active ingredients for the same effect.

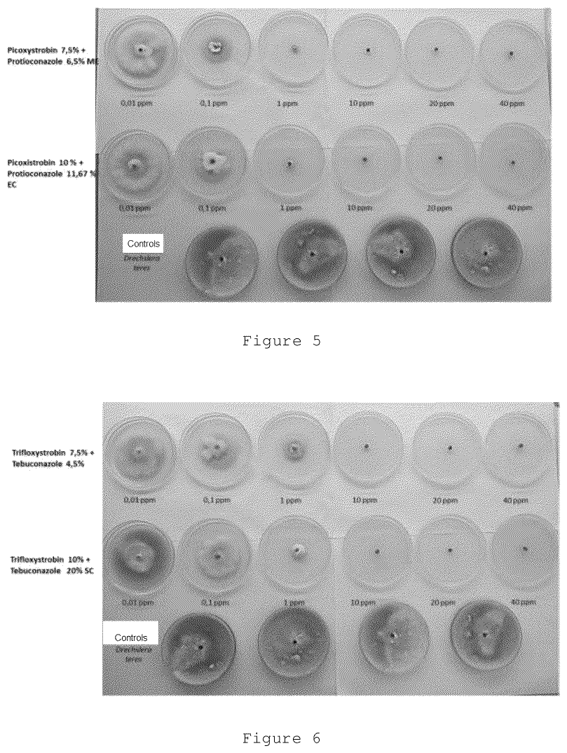

The in vitro sensitivity test result of Drechslera teres to the formulation of the composition (picoxystrobin 7.5%+prothioconazole 6.5% ME) vs commercial control (picoxystrobin 10%+prothioconazole 11.67% EC)) can be seen in FIG. 5.

### 16. D Trifloxystrobin+Tebuconazole

In this case, total inhibition is observed at 10 ppm for both actives. However, the control (understood as a decrease in colony diameter growth) is better with the formulation of the present composition (trifloxitrobin 7.5+tebuconazole 4.5 ME) than with the commercial control (trifloxitrobin 10+tebuconazole 20 SC) at 0.1 ppm. In this case, twice as much active trifloxitrobin and half as much tebuconazole is present as the commercial control.

The in vitro sensitivity test result of Drechslera teres to the formulation of the composition (trifloxitrobin 7.5+tebuconazole 4.5 ME) vs commercial control (trifloxitrobin 10+tebuconazole 20 SC) can be seen in FIG. 6.

### Example 17: Microemulsion Dilution Test

A 5 ml of the concentrated emulsifier is brought to 100 ml of aqueous emulsion with standard water C (1000 ppm) at 30° C. The stability of this emulsion is evaluated in terms of the free amounts of “oil” or “cream” that separate while the emulsion is left to stand undisturbed for 0 min, 30 min, 2 h, in a bath at 30° C.

Initial emulsion: A 100 ml cylinder is filled with 95 ml of standard water at 30+1° C. and the formulated is carefully poured to the surface of the water (5 ml at the same temperature as the water). The cylinder is capped and inverted once.

Stability tests in broth (water 1000 ppm)

| Formulation | 0 min | 30 min | 2 hs |
|---|---|---|---|
| Trifloxitrobin | no evidence of | no evidence of | no evidence of |
| 7.5 + | microemulsion | microemulsion | microemulsion |
| Tebuconazole | breakage, nor | breakage or | breakage or |
| 4.5 ME | precipitates | precipitates | precipitates |
| Trifloxitrobin | no separation | a higher amount | a higher amount |
| 10 + | is observed | of solid | of solid |
| Tebuconazole | | precipitate is | precipitate is |
| 20 SC | | visible | visible |
| | | (about 1%) | (about 2%) |
| Azoxystrobin | no evidence of | no evidence of | no evidence of |
| 7.5% + | microemulsion | microemulsion | microemulsion |
| Epoxiconazole | breakage or | breakage or | breakage or |
| 4.5% ME | precipitates | precipitates | precipitates |
| Azoxystrobin | no precipitate | a higher amount | higher amount of |
| 25% + | or separation | of solid | solid |
| Epoxiconazole | is observed | precipitate is | precipitate is |
| 12.5% SC | | visible | visible (about |
| | | (about 1%) | 1.5%) |

### Conclusions:

The commercial products tested show lack of stability in the application broth which would generate in a spray without agitation the formation of a concentration gradient of the active ingredients over time, where at the beginning of the application would have a higher concentration of the active ingredients dispersed in the broth and as the application progresses the broth would have lower concentration of these due to the precipitation of the same, translating into a lower efficiency of control of pathogens). The formulation of the composition remains unchanged over time (as a microemulsion) allowing a homogeneous product that can be applied without losses. This also demonstrates that the formulations of the present composition can be applied without the addition of adjuvants or additional products commonly used for the application of currently available products such as those tested herein.

1. Table of Formulations

| | |
|---|---|
| FORMULATED 1 COMMERCIAL TYPE | |
| SC | FORMULATED 2 GROOVES TYPE ME |

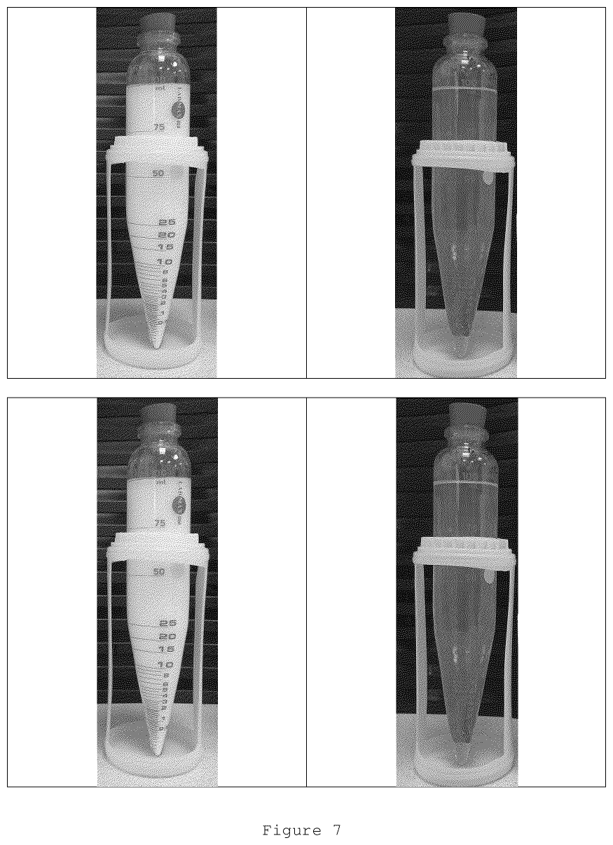

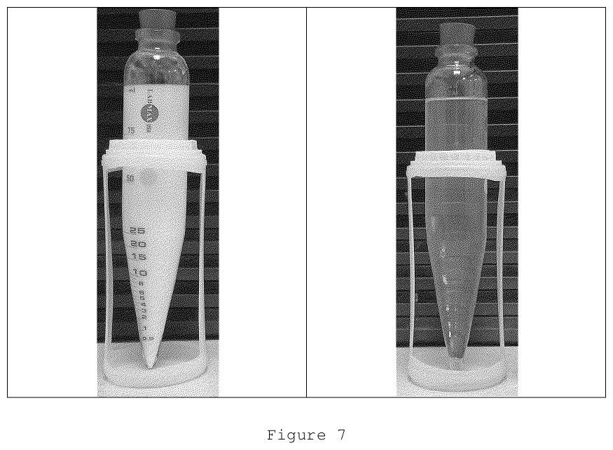

Trifloxystrobin + Tebuconazole (see FIG. 7)

| | |
|---|---|
| Time 0: Formulated 1 no | Time 0: Formulated 2 no |
| separation is observed. | evidence of emulsion |
| | breakage or precipitates. |
| Time 30 min: Formulated 1 | Time 30 min: Formulated 2 no |
| already shows a higher | evidence of emulsion |
| amount of precipitated | breakage or precipitates. |
| solids (about 1%). | |
| Time 2 hrs: Formulated 1 | Time 2 hrs: Formulated 2 no |
| already shows a higher | evidence of emulsion |
| amount of solid precipitate | breakage or precipitates. |
| (about 2%). | |

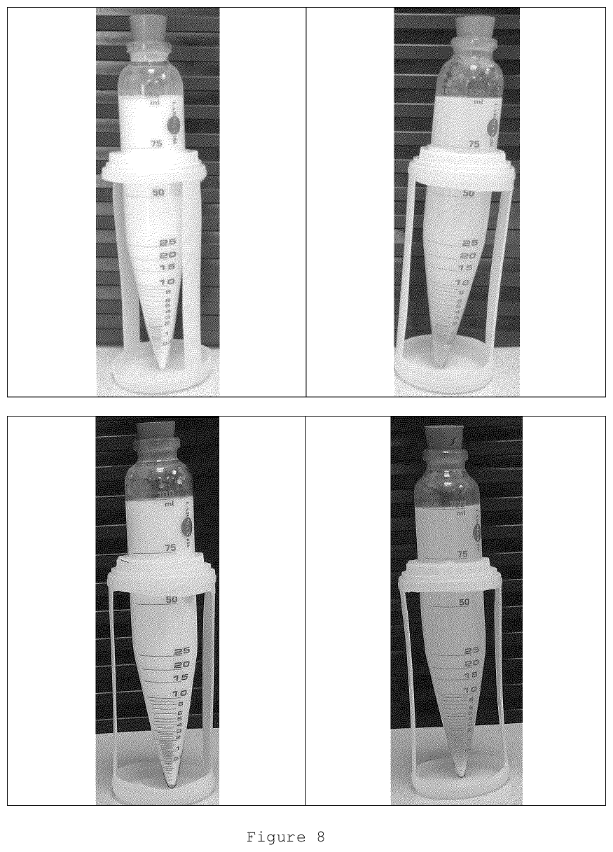

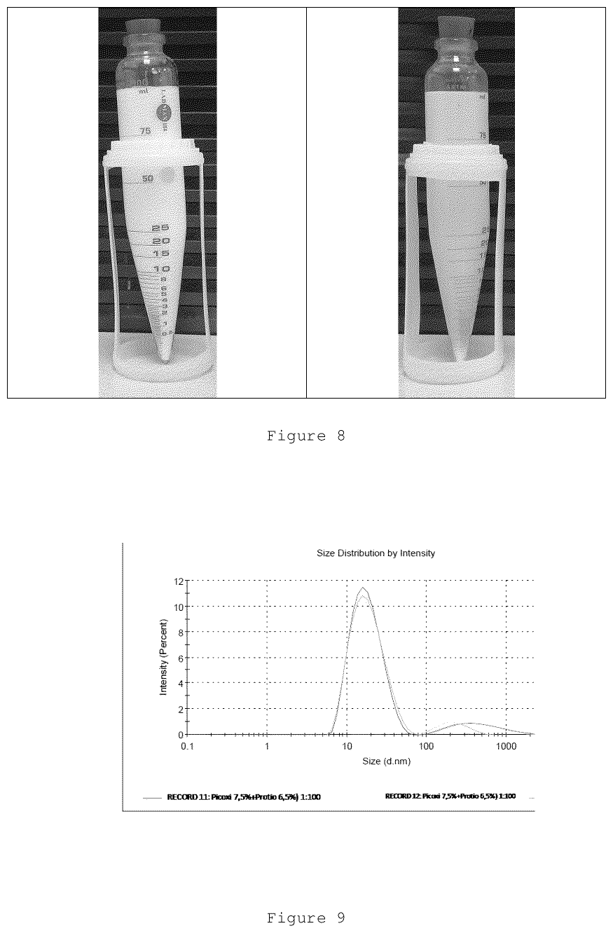

Azoxystrobin + Epoxiconazole (See FIG. 8)

| | |
|---|---|
| Time 0: Formulated 1 no | Time 0: Formulated 2 no |
| precipitate or separation is | evidence of emulsion |
| observed. | breakage or precipitates. |
| Time 30 min: Formulated 1 | Time 30: Formulated 2 no |
| already shows higher amount | evidence of emulsion |
| of precipitate solids (about | breakage or precipitates. |
| 1%) | |
| Time 2 hrs: Formulated 1 | Time 2 hrs: Formulated 2 no |
| already shows a higher | evidence of emulsion |
| amount of precipitate solids | breakage or precipitates. |
| (about 1.5%). | |

### Example 18: Determination of the Particle Size of the Microemulsion of the Present Composition

In order to determine the particle size of the microemulsion according to Example 1, the measurement was performed by the light scattering technique using Nano Zetasizer equipment (Serial Number: MAL1188877), using water as dispersant, at a refractive index of the sample of 1.34, absorption of the material: 0.019, refractive index of the dispersant: 1.330 and viscosity (cP): 0.8872. The measurement was carried out at 25° C., measurement duration 70 seconds, measurement position (mm): 4.65 (see FIG. 9).

The measurement was performed in duplicate, giving an average diameter of 18.04 nanometers in diameter

1. A fungicidal composition in microemulsion form comprising: a first component selected from the group consisting of triazolinthione and triazoles fungicides; and a second component consisting of methoxyacrylates, wherein the concentration of the first component is in the range of 2.5% w/v to 9.0% w/v and the concentration of the second component is in the range of 3.5% w/v to 10.0% w/v.

2. The fungicidal composition in microemulsion form according to claim 1, further comprising: a mixture of non-ionic surfactants; solvents selected from water soluble solvents and water insoluble solvents; fatty tallow alkyl amine ethoxylated with 10-15 moles of ethylene oxide or coconut alkyl amine ethoxylated with 10-15 moles of ethylene oxide; a wetting agent of ethyl sulfosuccinate or dioctyl sulfosuccinate, methyl salicylate, Fatty Acid Methyl Esters (FAME), silicone defoamer and water as dispersant.

3. The fungicidal composition in microemulsion form according to claim 1, wherein the first component consisting of triazolinthione and/or triazoles fungicides are selected from prothioconazole, epoxiconazole, and tebuconazole.

4. The fungicidal composition in microemulsion form according to claim 1, wherein the second component is selected from picoxystrobin, azoxystrobin, and trifloxystrobin.

5. The fungicidal composition in microemulsion form according to claim 1 wherein the nonionic and/or anionic surfactants are selected from Noniphenol of 10 moles OE, alcohol (C12-C15) ethoxylated with 7 moles EO dilute, and a block copolymer surfactant alkoxylate, and mixtures thereof.

6. The fungicidal composition in microemulsion form according to claim 5, wherein the total amount of non-ionic surfactants ranges between 9.85 and 25% w/v.

7. The fungicidal composition in microemulsion form according to claim 1 wherein the total amount of fatty tallow alkyl amine ethoxylated with 10-15 moles of ethylene oxide or coconut alkyl amine ethoxylated with 10-15 moles of ethylene oxide in the composition ranges between 3.21 and 10% w/v.

8. The fungicidal composition in microemulsion form according to claim 2 wherein the water-soluble solvents are selected from N-methylpyrrolidone, cyclohexanone, dimethyl sulfoxide (DMSO) or mixtures thereof.

9. The fungicidal composition in microemulsion form according to claim 1 wherein the water insoluble solvent is toluene.

10. The fungicidal composition in microemulsion form according to claim 1 wherein the total amount of wetting agent ethyl sulfosuccinate or dioctyl sulfosuccinate or sodium dioctyl sulfosuccinate in the composition ranges from 2.48 to 10.0% w/v.

11. The fungicidal composition in microemulsion form according to claim 1 wherein the total amount of methyl salicylate in the composition ranges from 5.78 to 15.0% w/v.

12. The fungicidal composition in microemulsion form according to claim 1 wherein the total amount of water in the composition ranges from 1 to 58% w/v.

13. The fungicidal composition in microemulsion form according to claim 2 comprising the following components: picoxystrobin 7.5% w/v, prothioconazole 6.5% w/v, N-methylpyrrolidone 21.0% w/v, methyl salicylate 13.5% w/v, nonylphenol ethoxylated with 10 moles of EO 13.5% w/v, ethylene oxide/propylene oxide block copolymer surfactant initiated with 4-butoxy-iso-butane 9.5% w/v, a wetting agent based on ethyl sulfosuccinate or dioctyl sulfosuccinate or the sodium dioctyl sulfosuccinate salt thereof 5.8% w/v, a formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 16.5% w/v, fatty acid methyl esters 3.0% w/v, water 2.0% w/v and silicone defoamer 0.01% w/v.

14. The fungicidal composition in microemulsion form according to claim 1 comprising the following components: picoxystrobin 7.5% w/v, prothioconazole 6.5% w/v, N-methylpyrrolidone 21.0% w/v, methyl salicylate 13.5% w/v, alcohol (C12-C15) ethoxylated with 7 moles EO diluted 13.5% w/v, ethylene oxide/propylene oxide block copolymer surfactant initiated with 4-butoxy-iso-butane 9.5% w/v, a wetting agent based on ethyl sulfosuccinate or dioctyl sulfosuccinate or the sodium dioctyl sulfosuccinate salt thereof 5.8% w/v, a formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 16.5% w/v, fatty acid methyl esters 3.0% w/v, water 2.0% w/v and silicone defoamer 0.01% w/v.

15. The fungicidal composition in microemulsion form according to claim 1 comprising the following components: picoxystrobin 7.5% w/v, prothioconazole 6.5% w/v, dimethyl sulfoxide (DMSO) 11.0% w/v, methyl salicylate 13.0% w/v, nonylphenol ethoxylated with 10 moles of EO or alcohol (C12-C15) ethoxylated with 7 moles EO diluted 13.5% w/v, ethylene oxide/propylene oxide block copolymer surfactant initiated with 4-butoxy-iso-butane 9.5% w/v, a wetting agent based on ethyl sulfosuccinate or dioctyl sulfosuccinate or the sodium dioctyl sulfosuccinate salt thereof 5.8% w/v, a formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 26.5% w/v, fatty acid methyl esters 3.0% w/v, water 2.0% w/v and silicone defoamer 0.01% w/v.

16. The fungicidal composition in microemulsion form according to claim 1 comprising the following components: picoxystrobin 3.5% w/v, prothioconazole 2.5% w/v, N-methylpyrrolidone 9.0% w/v, methyl salicylate 5.78% w/v, nonylphenol ethoxylated with 10 moles of EO or alcohol (C12-C15) ethoxylated with 7 moles EO diluted 5.78% w/v, ethylene oxide/propylene oxide block copolymer surfactant initiated with 4-butoxy-iso-butane 4.07% w/v, a wetting agent based on ethyl sulfosuccinate or dioctyl sulfosuccinate or its dioctyl sulfosuccinate salt 2, 48% w/v, a formulation adjuvant composed of selected fatty tallow alkyl amine ethoxylated with 10-15 moles of ethylene oxide or coconut alkyl amine ethoxylated with 10-15 moles of ethylene oxide 3.21% w/v, cyclohexanone 7.06% w/v, fatty acid methyl esters 1.28% w/v, water 58.0% w/v and silicone defoamer 0.01% w/v.

17. The fungicidal composition in microemulsion form according to claim 1 comprising the following components: picoxystrobin 3.5% w/v, prothioconazole 2.5% w/v, dimethyl sulfoxide (DMSO) 4.71% w/v, methyl salicylate 5.57% w/v, nonylphenol ethoxylated with 10 moles of EO or alcohol (C12-C15) ethoxylated with 7 moles EO diluted 5, 78% w/v, ethylene oxide/propylene oxide block copolymer surfactant initiated with 4-butoxy-iso-butane 4.07% w/v, a wetting agent based on ethyl sulfosuccinate or dioctyl sulfosuccinate or the sodium dioctyl sulfosuccinate salt thereof 2.48% w/v, a formulation adjuvant composed of selected fatty tallow alkyl amine ethoxylated with 10-15 moles of ethylene oxide or coconut alkyl amine ethoxylated with 10-15 moles of ethylene oxide 3.21% w/v, cyclohexanone 11.34% w/v, fatty acid methyl esters 1.28% w/v, water 58.0% w/v and silicone defoamer 0.01% w/v.

18. The fungicidal composition in microemulsion form according to claim 1 comprising the following components: picoxystrobin 10.0% w/v, prothioconazole 9.0% w/v, N-methylpyrrolidone 21.0.0% w/v, methyl salicylate 13.5% w/v, nonylphenol ethoxylated with 10 moles of EO or alcohol (C12-C15) ethoxylated with 7 moles EO diluted 13.5% w/v, ethylene oxide/propylene oxide block copolymer surfactant initiated with 4-butoxy-iso-butane 9.5% w/v, a wetting agent based on ethyl sulfosuccinate or dioctyl sulfosuccinate or the sodium dioctyl sulfosuccinate salt thereof 5.8% w/v, a formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 16.5% w/v, water 1.0% w/v and silicone defoamer 0.01% w/v.

19. The fungicidal composition in microemulsion form according to claim 1 comprising the following components: picoxystrobin 10.0% w/v, prothioconazole 9.0% w/v, dimethyl sulfoxide (DMSO) 11.0% w/v, methyl salicylate 13.0% w/v, nonylphenol ethoxylated with 10 moles of EO or alcohol (C12-C15) ethoxylated with 7 moles EO diluted 13.5% w/v, ethylene oxide/propylene oxide block copolymer surfactant initiated with 4-butoxy-iso-butane 9.5% w/v, a wetting agent based on ethyl sulfosuccinate or dioctyl sulfosuccinate or the sodium dioctyl sulfosuccinate salt thereof 5.8% w/v, a formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 26.5% w/v, water 1.0% w/v and silicone defoamer 0.01% w/v.

20. The fungicidal composition in microemulsion form according to claim 1 comprising the following components: azoxystrobin 7.5% w/v, epoxiconazole 4.5% w/v, N-methylpyrrolidone 22.0% w/v, methyl salicylate 13.75% w/v, nonylphenol ethoxylated with 10 moles of EO 13.5% w/v, ethylene oxide/propylene oxide block copolymer surfactant initiated with 4-butoxy-iso-butane 9.6% w/v, a wetting agent based on ethyl sulfosuccinate or dioctyl sulfosuccinate or the sodium dioctyl sulfosuccinate salt thereof 5.9% w/v, a formulation adjuvant composed of selected fatty tallow alkyl amine ethoxylated with 10-15 moles of ethylene oxide or coconut alkyl amine ethoxylated with 10-15 moles of ethylene oxide 7.56% w/v, toluene 16.7% w/v, fatty acid methyl esters 2.1% w/v, and water 1.7% w/v.

21. The fungicidal composition in microemulsion form according to claim 1 comprising the following components: azoxystrobin 7.5% w/v, prothioconazole 6.0% w/v, N-methylpyrrolidone 21.0% w/v, methyl salicylate 13.5% w/v, nonylphenol ethoxylated with 10 moles of EO 13.5% w/v, ethylene oxide/propylene oxide block copolymer surfactant initiated with 4-butoxy-iso-butane 9.5% w/v, a wetting agent based on ethyl sulfosuccinate or dioctyl sulfosuccinate or the sodium dioctyl sulfosuccinate salt thereof 5.8% w/v, a formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 16.5% w/v, fatty acid methyl esters 3.0% w/v, and water 2.0% w/v.

22. The fungicidal composition in microemulsion form according to claim 1 comprising the following components: azoxystrobin 7.5% w/v, tebuconazole 4.5% w/v, N-methylpyrrolidone 22.0% w/v, methyl salicylate 13.75% w/v, nonylphenol ethoxylated with 10 moles of EO 13.5% w/v, ethylene oxide/propylene oxide block copolymer surfactant initiated with 4-butoxy-iso-butane 9.6% w/v, a wetting agent based on ethyl sulfosuccinate or dioctyl sulfosuccinate or the sodium dioctyl sulfosuccinate salt thereof 5.9% w/v, a formulation adjuvant composed of selected fatty tallow alkyl amine ethoxylated with 10-15 moles of ethylene oxide or coconut alkyl amine ethoxylated with 10-15 moles of ethylene oxide 7.5% w/v, cyclohexanone 16.7% w/v, fatty acid methyl esters 2.1% w/v, and water 1.7% w/v.

23. The fungicidal composition in microemulsion form according to claim 1 comprising the following components: trifloxitrobin 7.5% w/v, tebuconazole 4.5% w/v, N-methylpyrrolidone 25.0% w/v, methyl salicylate 15.0% w/v, nonylphenol ethoxylated with 10 moles of EO 15.0% w/v, ethylene oxide/propylene oxide block copolymer surfactant initiated with 4-butoxy-iso-butane 10.0% w/v, a wetting agent based on ethyl sulfosuccinate or dioctyl sulfosuccinate or its dioctyl sulfosuccinate sodium salt 10.0% w/v, a formulation adjuvant composed of selected fatty tallow alkyl amine ethoxylated with 10-15 moles of ethylene oxide or coconut alkyl amine ethoxylated with 10-15 moles of ethylene oxide 10.0% w/v, fatty acid methyl esters 7.0% w/v, and water 2.0% w/v.
